(19) United States
(12) Patent Application Publication
(10) Pub. No.: US 2024/0329829 A1
(43) Pub. Date: Oct. 3, 2024

(54) WRITING IDENTIFICATION SYSTEM AND METHOD

(71) Applicant: SILICON INTEGRATED SYSTEMS CORP., HSINCHU CITY (TW)

(72) Inventor: Ying-hu YEN, HSINCHU CITY (TW)

(73) Assignee: SILICON INTEGRATED SYSTEMS CORP., (omitted)

(21) Appl. No.: 18/608,357

(22) Filed: Mar. 18, 2024

(30) Foreign Application Priority Data
Mar. 31, 2023 (TW) 112112726

(51) Int. Cl. G06F 3/04883; G06F 3/0354; G06F 3/041; G06F 3/044

(52) U.S. Cl. CPC G06F 3/04883; G06F 3/03545; G06F 3/03547; G06F 3/04162; G06F 3/0441

(57) ABSTRACT

A writing identification system includes a touch control panel, an identification device, and a pairing device. The identification device includes a housing assembly detachably attached to a writing instrument. A trigger sensor is disposed in a first cover of the housing assembly for sensing displacement of the writing instrument. A wireless transmission module is disposed in the first cover. When the trigger sensor senses the displacement and a writing head of the writing instrument contacts a writing board, the wireless transmission module transmits a first identification signal. A power module is disposed in the housing assembly. The pairing device is configured to receive the first identification signal and a handwriting touch signal to generate a first pairing signal and transmit the first pairing signal to a user device.

### CROSS REFERENCE TO RELATED APPLICATIONS

This application claims priority to Taiwan Patent Application No. 112112726, filed Mar. 31, 2023, the disclosure of which is incorporated herein by reference in its entirety.

### BACKGROUND OF INVENTION

### 1. Field of Invention

The present application relates to an identification system and method, and particularly to a writing identification system and method that allows users to identify writing.

### 2. Related Art

The use of current whiteboards and whiteboard pens is common in meetings, teaching, or various occasions where information needs to be conveyed through writing assistance. However, the use of current whiteboards can only allow on-site personnel in front of the whiteboards to know the content on the whiteboards, but cannot provide the content of the information to remote or off-site participants. Therefore, industries have developed an electronic whiteboard and an electronic whiteboard writing instrument, and through the Internet, remote users can also obtain the content of the on-site electronic whiteboard in real time.

However, there are many drawbacks in the use of current electronic whiteboard pens and electronic whiteboards. For example, traditional whiteboards and whiteboard pens cannot be used and become incompatible waste. In addition, purchasing electronic whiteboard pens and electronic whiteboards will undoubtedly increase costs and cause a waste of resources. Furthermore, if users want to write in different colors on the electronic whiteboard, users must first use an electronic whiteboard pen to set a desired color by a setting panel of the electronic whiteboard, so that writing in different colors can be feasible, which is quite inconvenient in use. In view of this, it is imperative to provide a writing identification system and method to solve the above problems.

### SUMMARY OF INVENTION

An object of the present invention is to provide a writing identification system and method that can be compatible with current whiteboard pens and whiteboards, and can easily and accurately identify the writing color of a single or a plurality of writing instruments used at the same time for user devices.

Another object of the present invention is to provide a writing identification system and method that can simply and accurately identify the use of electronic erasers for user devices.

In order to achieve the above objects, the present application provides a writing identification system used for at least a user device to identify a writing instrument and handwriting with the writing instrument on a writing board, and the writing identification system includes a touch control panel, an identification device, and a pairing device. The touch control panel is disposed on a back of the writing board and configured to generate a handwriting touch signal according to the handwriting of the writing instrument. The identification device includes a housing assembly, a trigger sensor, a wireless transmission module, and a power module. The housing assembly is detachably attached to the writing instrument and includes a first cover disposed on an end of the writing instrument opposite to a writing head included in the writing instrument. The trigger sensor is disposed in the first cover and configured to sense displacement of the writing instrument. The wireless transmission module is disposed in the first cover and electrically connected to the trigger sensor. Specifically, the wireless transmission module, in response to that the trigger sensor senses the displacement and a time the writing head of the writing instrument contacts the writing board, transmits a first identification signal. The power module is disposed in the housing assembly and configured to supply power to the trigger sensor and the wireless transmission module. The pairing device is electrically connected to the touch control panel and generating, in response to receiving the first identification signal and the handwriting touch signal, a first pairing signal and transmitting the first pairing signal to a remote device.

Preferably, the trigger sensor includes a trigger portion positioned in contact with an end of the writing instrument away from the writing head and configured to sense the displacement of the writing instrument when contact pressure is applied on the writing board from the writing instrument.

Preferably, the displacement of the writing instrument includes acceleration of the writing instrument, and the trigger sensor is configured to sense the acceleration of the writing instrument moving from outside the writing board to be in contact with the writing board.

Preferably, the housing assembly further includes a housing body configured along the writing instrument, and the housing body comprises a mounting opening positioned close to the writing head of the writing instrument. The first cover is installed on an end of the housing body away from the mounting opening.

Preferably, the housing assembly further includes a second cover installed on an end of the mounting opening of the housing body, and the second cover includes a through hole through which the writing head passes.

Preferably, the first pairing signal includes identification data containing a writing color of the writing instrument. Specifically, the time the writing head of the writing instrument contacts the writing board excludes a writing time when the writing head writes on the writing board to generate the handwriting, and the wireless transmission module does not transmit the first identification signal during the writing time.

Preferably, the writing identification system further includes an electronic eraser including an eraser body, a wiping portion, and at least a conductive element. The conductive element is disposed in the wiping portion or the eraser body.

Preferably, the electronic eraser further includes an identification element disposed in the eraser body, and the conductive element is disposed in the wiping portion and connected to the identification element. When the wiping portion contacts the writing board, the identification element sends out a second identification signal, and when the wiping portion moves on the writing board, the touch control panel generates a wiping touch signal, and the pairing device, in response to receiving the second identification signal and the wiping touch signal, generates a second pairing signal and transmits the second pairing signal to the user device. The writing identification system of claim 7, wherein the electronic eraser further comprises an identification element disposed in the eraser body, and the conductive element is disposed in the wiping portion and connected to the identification element, wherein when the wiping portion contacts the writing board, the identification element sends out a second identification signal, and when the wiping portion moves on the writing board, the touch control panel generates a wiping touch signal, and the pairing device, in response to receiving the second identification signal and the wiping touch signal, generates a second pairing signal and transmits the second pairing signal to the user device.

Preferably, when the wiping portion contacts the writing board, a coupling effect is formed between the touch control panel and the conductive element, and the touch control panel, in response to the coupling effect, sends a second identification signal, and when the wiping portion moves on the writing board, the touch control panel generates a wiping touch signal, and the pairing device, in response to receiving the second identification signal and the wiping touch signal, generates a second pairing signal and transmits the second pairing signal to user device.

Preferably, the pairing device includes a processor and a signal transceiver module electrically connected to the processor.

The present application further provides a writing identification method for at least a user device to identify a writing instrument and handwriting with the writing instrument on a writing board, and the method includes an electronic writing board setting step including setting a touch control panel on a back of the writing board. The touch control panel generates a handwriting touch signal according to the handwriting of the writing instrument. An identification device setting step includes installing an identification device on the writing instrument, and the identification device includes a housing assembly, a trigger sensor, a wireless transmission module, and a power module. The housing assembly is detachably attached to the writing instrument and including a first cover disposed on an end of the writing instrument opposite to a writing head included in the writing instrument. The trigger sensor is disposed in the first cover and configured to sense displacement of the writing instrument. The wireless transmission module is disposed in the first cover and electrically connected to the trigger sensor. The power module is disposed in the housing assembly and configured to supply power to the trigger sensor and the wireless transmission module. An identification step includes using the wireless transmission module, in response to that the trigger sensor senses the displacement and a time the writing head of the writing instrument contacts the writing board, to transmit a first identification signal. A pairing step includes electrically connecting a pairing device to the touch control panel for receiving the first identification signal and the handwriting touch signal to generate a first pairing signal and transmit the first pairing signal to the user device.

Preferably, the first pairing signal includes identification data containing a writing color of the writing instrument. Specifically, the time the writing head of the writing instrument contacts the writing board excludes a writing time when the writing head writes on the writing board to generate the handwriting, and the wireless transmission module does not transmit the first identification signal during the writing time.

Preferably, the housing assembly further includes a housing body configured along the writing instrument, the housing body includes a mounting opening, and the identification device setting step further includes installing the housing body on the writing instrument such that the mounting opening is positioned close to the writing head of the writing instrument, and installing the first cover on an end of the housing body away from the mounting opening.

Preferably, the housing assembly further includes a second cover with a through hole, and the identification device setting step further includes installing the second cover on an end of the mounting opening of the housing body such that the writing head of the writing instrument is exposed to the through hole.

Preferably, the pairing device includes a processor and a signal transceiver module electrically connected to the processor, and the pairing step includes using the signal transceiver module to receive the first identification signal through a wireless transmission manner, and receive the handwriting touch signal; using the processor to pair the first identification signal with the handwriting touch signal through an algorithm to generate the first pairing signal; and using the signal transceiver module to transmit the first pairing signal to the user device through the Internet in a wireless transmission manner.

Preferably, the writing identification method further includes providing an electronic eraser, comprising an eraser body, a wiping portion, at least a conductive element, and an identification element disposed in the eraser body. The conductive element is disposed in the wiping portion and connected to the identification element. When the wiping portion contacts the writing board, the identification element sends out a second identification signal, and when the wiping portion moves on the writing board, the touch control panel generates a wiping touch signal, and the pairing device, in response to receiving the second identification signal and the wiping touch signal, generates a second pairing signal and transmits the second pairing signal to the user device.

Preferably, the writing identification method further includes providing an electronic eraser, including an eraser body, a wiping portion, and at least a conductive element. The conductive element is provided in the wiping portion or the eraser body. When the wiping portion contacts the writing board, a coupling effect is formed between the touch control panel and the conductive element, and the touch control panel, in response to the coupling effect, sends a second identification signal, and when the wiping portion moves on the writing board, the touch control panel generates a wiping touch signal, and the pairing device, in response to receiving the second identification signal and the wiping touch signal, generates a second pairing signal and transmits the second pairing signal to user device.

The writing identification system and method provided in the present application can be used with general commercially available whiteboard pens and whiteboards. The identification device is installed on the writing instrument and the first identification signal is transmitted to the writing instrument using a wireless signal transmission method. The pairing device receives the first identification signal and the handwriting touch signal sent by the touch control panel to generate the first pairing signal and transmits the first pairing signal to the user device. In addition, the writing identification system and method of the present application receives the second identification signal and the wiping touch signal through the pairing device, and then sends the second pairing signal for identifying the eraser. With the above writing identification system and method, when intending to use writing instruments of different colors, users only need to pick up the writing instrument of the required color and write on the writing board. It is the same as using general whiteboard pens, without the need to set the color through setting functions of traditional electronic whiteboards, which is not only convenient, fast and accurate to achieve the identification effect, but also remains the use of original whiteboard pens and whiteboards, thus effectively reducing costs and preventing the waste of resources.

### BRIEF DESCRIPTION OF DRAWINGS

To describe the technical solutions in the embodiments of the present invention, the following briefly introduces the accompanying drawings for describing the embodiments. Apparently, the accompanying drawings in the following description show merely some embodiments of the present invention, and a person skilled in the art may still derive other drawings from these accompanying drawings without creative efforts.

FIG. 1 is a schematic exploded view of an identification device of a writing identification system according to an embodiment of the present application.

FIG. 2 is a schematic assembly view of the identification device of FIG. 1.

FIG. 3 is a schematic assembly view of the identification device of FIG. 2 and a writing instrument.

FIG. 4 is a schematic exploded view of an identification device of a writing identification system according to an embodiment of the present application.

FIG. 5 is a schematic assembly view of the identification device of FIG. 4.

FIG. 6 is a schematic assembly view of the identification device of FIG. 5 and a writing instrument.

FIG. 7 is a schematic structural view showing the assembly of a touch control panel, a pairing device, and a writing board according to an embodiment of the present application.

FIG. 8 is a schematic structural view of an electronic eraser according to an embodiment of the present application.

FIG. 9 is a schematic structural view of an electronic eraser according to another embodiment of the present application.

FIG. 10 is a schematic structural view of a writing identification system according to an embodiment of the present application.

FIG. 11 is a timing diagram of a writing identification system in operation according to an embodiment of the present application.

FIG. 12 is a flowchart of a writing identification method according to an embodiment of the present application.

### DESCRIPTION OF PREFERRED EMBODIMENTS

In order to make the purpose, technical solutions, and effects of the present application clearer and more explicit clearer, the present application will be further described in detail below with reference to the drawings and examples. It should be understood that the specific embodiments described here are only used to explain the application. The word “embodiment” used in the description of the application is meant to be used as an example, illustration or illustration, and is not intended to limit the application. Furthermore, the article “a” as used in the specification of this application and the appended claims may generally be construed to mean “one or more” unless otherwise specified or the singular form is clear from the context. Furthermore, in the accompanying drawings, elements with similar or identical structures and functions are represented by the same element numbers.

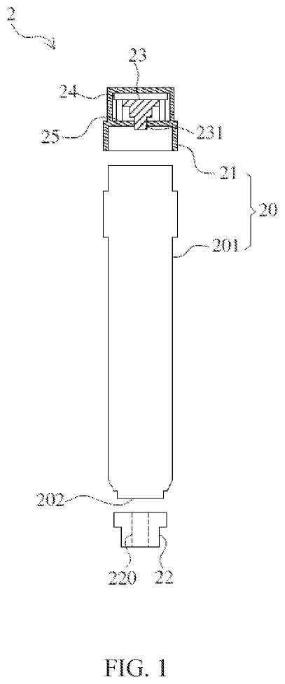

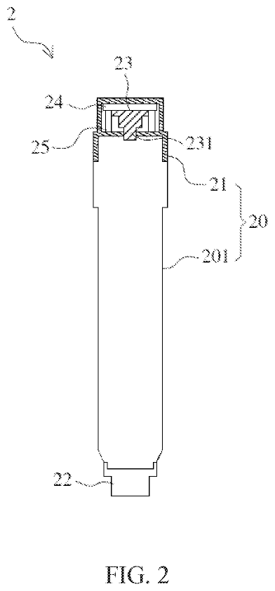

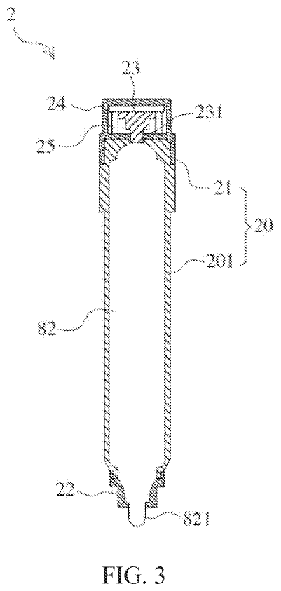

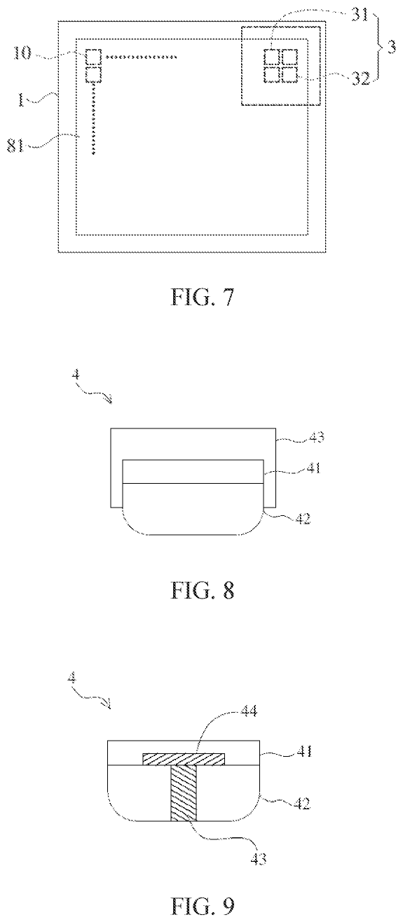

This application relates to a writing identification system that is applicable to commercially available whiteboards and whiteboard pens and allows one or more user devices to identify the whiteboard pens and handwriting of the whiteboard pens on whiteboards. Please refer to FIGS. 1 to 3 showing an identification device according to an embodiment of the present application, and FIG. 7 showing a touch control panel according to an embodiment of the present application. FIG. 1 is a schematic exploded view of an identification device 2 of a writing identification system 100 according to an embodiment of the present application. FIG. 2 is a schematic assembly view of the identification device 2 of FIG. 1. FIG. 3 is a schematic assembly view of the identification device 2 of FIG. 2 and a writing instrument 82. FIG. 7 is a schematic structural view showing the assembly of a touch control panel 1, a pairing device 3, and a writing board 81 according to an embodiment of the present application. Referring to FIG. 7 first, the present application provides the touch control panel 1, which is disposed on a back of the writing board 81 and is configured to generate a handwriting touch signal according to handwriting of the writing instrument 82, and the touch control panel 1 is connected to a paired device 3. It should be noted that the handwriting touch signal includes any content displayed on the writing board such as text or patterns. In some embodiments, the writing board 81 can be a general whiteboard, but is not limited to white, and the writing instrument 82 can be a general whiteboard pen with an ink cartridge.

In some embodiments, the writing instrument 82 can also be a writing instrument with a thicker tip than a whiteboard pen, such as a marker pen, or a writing instrument with a thinner tip than a whiteboard pen, such as a Sharpie marker, or a writing instrument without an ink cartridge, such as a crayon or other pen that can be written on the writing board 81. In addition, the touch control panel 1 may be a projected touch control panel, including a plurality of touch sensing units 10 arranged in an array, using the working principle of projected capacitance to generate a coupling effect through contact between a contact object and the writing board 81. Then the change in capacitance is sensed so that a touch position is determined. In other embodiments, the touch control panel 1 may also be a resistive, optical, electromagnetic, or ultrasonic touch control panel type, which is not specifically limited in this application.

Referring to FIGS. 1 to 3, the identification device 2 according to the embodiment of the present application includes a housing assembly 20, a trigger sensor 23, a wireless transmission module 24, and a power module 25. As shown in FIGS. 1 to 3, the housing assembly 20 is detachably attached to the writing instrument 82 and includes a housing body 201, a first cover 21, and a second cover 22. Specifically, the housing body 201 is configured along the writing instrument 82, and the housing body 201 includes a mounting opening 202 positioned close to the writing head 821 of the writing instrument 82. The first cover 21 is disposed on one end of the writing instrument 82 opposite to the writing head 821, and can be installed on an end of the housing body 201 away from the mounting opening 202 by means of screw lock, buckle, or tight fit. The second cover 22 is installed on an end of the mounting opening 202 of the housing body 201 and includes a through hole 220. In assembly, the mounting opening 202 of the housing body 201 is mounted to the writing instrument 82 from a rear end of the writing instrument 82, and then the first cover 21 and the second cover 22 are assembled, respectively, in such a way that the writing head 821 is exposed to the through holes 220 of the second cover 22. Accordingly, the assembly of the housing assembly 20 and the writing instrument 82 is completed. It should be noted that the housing body 201 may be shaped into two pieces of shells being fastened on the writing instrument 82 from both sides of the writing instrument 82. The configuration of the housing body 201 is not limited in this application. It is particularly noted that the configuration of the housing assembly 20 of the present application can be customized according to commercially available whiteboard pens to meet different needs of users.

Still referring to FIGS. 1 to 3, the trigger sensor 23 is disposed in the first cover 21 for sensing the displacement of the writing instrument 82. The wireless transmission module 24 is disposed in the first cover 21 and electrically connected to the trigger sensor 23. In some embodiments, the wireless transmission module 24 is configured to transmit wireless signals through, for example, a wireless network (Wi-Fi), a wireless sensor network (Bluetooth), or a mobile network. In other embodiments, the wireless transmission module 24 may be an optical signal wireless transmission module that emits optical signals in a pulse manner. The power module 25 is disposed in the first cover 21 to supply power to the trigger sensor 23 and the wireless transmission module 24. In some embodiments, the power module 25 may use a mercury battery to supply power, but is not limited thereto. Specifically, the trigger sensor 23, the wireless transmission module 24, and the power module 25 are located at the rear end of the writing instrument 82. Specifically, the trigger sensor 23 includes a trigger portion 231, which is in contact with an end of the writing instrument 82 away from the writing head 821. In this embodiment, the trigger sensor 23 is a pressure sensor for sensing the displacement caused by contact pressure when the writing head 821 of the writing instrument 82 contacts the writing board 81.

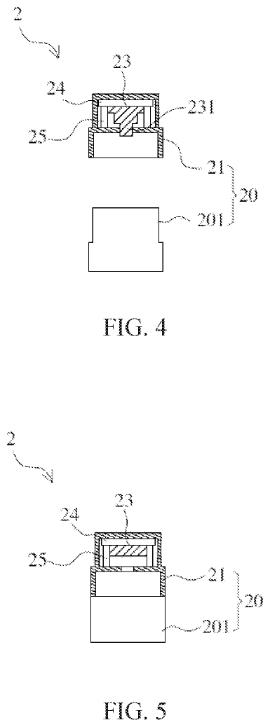

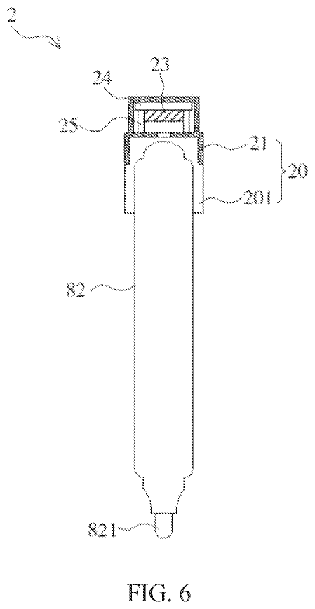

Please refer to FIGS. 4 to 6 for an identification device according to another embodiment of the present application. FIG. 4 is a schematic exploded view of an identification device of a writing identification system according to an embodiment of the present application. FIG. 5 is a schematic assembly view of the identification device of FIG. 4. FIG. 6 is a schematic assembly view of the identification device of FIG. 5 and a writing instrument. The difference between this embodiment and the previous embodiments mainly lies in the configuration of the housing assembly 20 and the trigger sensor 23. As shown in FIG. 4, an identification device 2 in this embodiment of the present application includes a housing assembly 20, a trigger sensor 23, a wireless transmission module 24, and a power module 25. The housing assembly 20 includes a housing body 201 and a first cover 21. Particularly, in this embodiment, the configuration of the housing body 201 only needs to be considered so that it can be assembled with the writing instrument 82 and is not necessary to be shaped along the entire housing body. However, the same configuration as the housing body of the previous embodiment can also be used in this embodiment. Specifically, the housing assembly 20 in this embodiment does not include the second cover 22. In addition, an assembly manner of the first cover 21 and the housing body 201, and the arrangement of the trigger sensor 23, the wireless transmission module 24, and the power module 25 are the same as the embodiments shown in FIGS. 1 to 3 and will not be repeated here. Specifically, in this embodiment, the trigger sensor 23 is an acceleration sensor configured to sense the acceleration of the writing instrument 82 moving from outside the writing board 81 to be in contact with the writing board 81.

Referring to FIG. 7, the pairing device 3 is connected to the touch control panel 1 through a flexible cable (not shown), and includes a processor 31 and a signal transceiver module 32 electrically connected to the processor 31. In some embodiments, the processor 31 may be a microcontroller (MCU). The signal transceiver module 32 is a wireless signal transceiver module that can receive wireless signals sent by the wireless transmission module 24, such as a Wi-Fi module, and can connect to user devices via the Internet.

The writing identification system of the present application may also be applicable to an eraser for cleaning the handwriting. Referring to FIGS. 8 and 9, FIG. 8 is a schematic structural view of an electronic eraser according to an embodiment of the present application, and FIG. 9 is a schematic structural view of an electronic eraser according to another embodiment of the present application. As shown in FIG. 8, in this embodiment, the electronic eraser 4 includes an eraser body 41, a wiping portion 42, and a conductive element 43. Specifically, the conductive element 43 is disposed in and arranged around the eraser body 41. In another embodiment, the wiping portion 42 can be made of conductive cloth and has the same function as the conductive element 43. Specifically, the function of the conductive element 43 is to form a coupling effect with the touch control panel 1 to change the capacitance of the touch control panel 1. A range of the capacitance change can be preset as a basis for determining whether it is an electronic eraser 4.

As shown in FIG. 9, the difference between the electronic erasers 4 shown in this embodiment and FIG. 8 lies in ways of the electronic erasers 4 being identified are different. The electronic eraser 4 shown in FIG. 9 further includes an identification element 44 disposed in the eraser body 41, and a conductive element 43 is disposed in the wiping portion 42 and connected to the identification element 44. Specifically, the electronic eraser 4 in this embodiment sends a wireless signal to the pairing device 3 in a wireless transmission mode through the identification element 44 for identification as an electronic eraser.

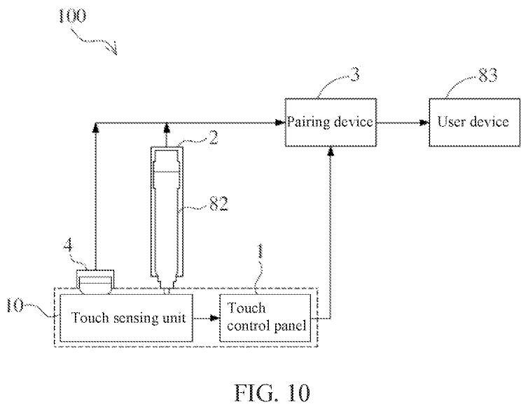

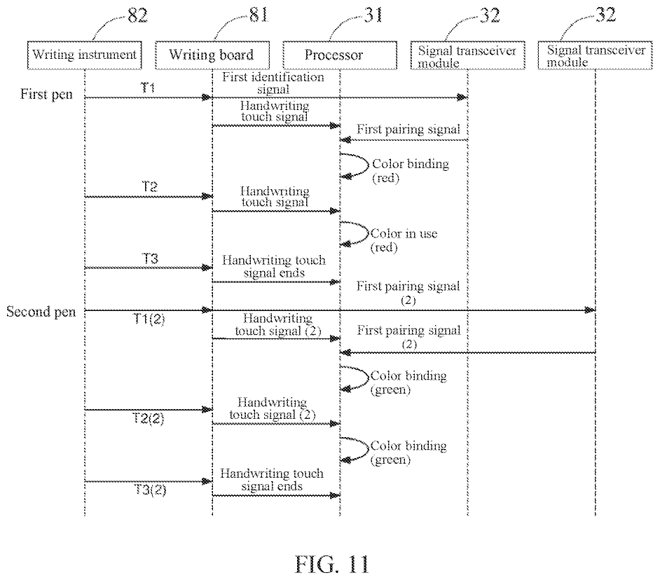

Referring to FIGS. 10 and 11, FIG. 10 is a schematic structural view of the writing identification system 100 according to an embodiment of the present application. FIG. 11 is a timing diagram of the writing identification system 100 in operation according to an embodiment of the present application. As shown in FIG. 10, the writing identification system 100 of the present application includes the touch control panel 1, the identification device 2, the pairing device 3, and the electronic eraser 4, and can be used with a general writing instrument and writing board. The writing identification system 100 of the present application uses a method of pairing the first identification signal and the handwriting touch signal or pairing the second identification signal and the wiping touch signal to identify a writing instrument or an electronic eraser to present an actual writing effect or cleaning effect.

Still referring to FIGS. 10 and 11 together with FIG. 3, taking the identification device 2 configured with a press sensor as the trigger sensor 23 as an example, when the writing head 821 of the writing instrument 82 contacts the writing board 81 at a first time T1, the trigger sensor 23 is pressed due to the reaction force generated by the writing instrument 82, so that the displacement of the writing instrument 82 is being sensed, and the trigger sensor 23 sends the first identification signal to the pairing device 3 through the wireless transmission module 24 at the first time T1. In addition, when the writing head 821 writes on the writing board 81, the touch control panel 1 generates the handwriting touch signal according to the writing of the writing instrument 82. The pairing device 3 uses the signal transceiver module 32 to receive the first identification signal and the handwriting touch signal through wireless transmission, and uses the processor 31 to pair the first identification signal with the handwriting touch signal through an algorithm to generate the first pairing signal, and finally the first pairing signal is transmitted to the user device 83 through the Internet by means of wireless transmission through the signal transceiver module 32. In some embodiments, the first pairing signal includes at least identification data containing a writing color or a type of the writing instrument 82. In some embodiments, the user device 83 may be a server, a computer, a mobile phone, a tablet, a notebook computer, or an Internet-connected television, which is not limited thereto. It should be noted that in addition to the wireless transmission, the user device 83 and the pairing device 3 can also be connected to the touch control panel 1 through a wired transmission line.

Still referring to FIGS. 10 and 11 together with FIG. 6, taking the identification device 2 configured with an acceleration sensor as the trigger sensor 23 as an example, when the writing head 821 of the writing instrument 82 contacts the writing board 81 at the first time T1, the trigger sensor 23 senses the acceleration because the writing instrument 82 moves from the outside of the writing board 81 to be in contact with the writing board 81, and the first identification signal is sent to the pairing device 3 through the wireless transmission module 24 at the first time T1. When the writing head 821 writes on the writing board 81, the touch control panel 1 generates a handwriting touch signal according to the handwriting of the writing instrument 82. The pairing device 3 receives the first identification signal and the handwriting touch signal to generate a first pairing signal and transmits it to the user device 83.

It is particularly noted that, as shown in FIG. 11, the first time T1 does not include a writing time T2 when the writing head 821 moves on the writing board 81 to generate the handwriting, and the wireless transmission module 24 does not transmit the first identification signal during the writing time T2, that is, the first identification signal will only be sent out at the first time T1 in response to the writing head 821 contacts the writing board 81, so as to achieve power saving on the power module 25. In addition, the handwriting touch signal ends at an end time T3 when the writing instrument 82 leaves the writing board 81. It should be noted that the writing identification system 100 of the present application can also identify a plurality of writing instruments concurrently writing on the writing board. As shown in FIG. 11, when the first writing instrument 82 is in use, the second writing instrument 82 can also write on the writing board 81 at the same time, and the identification principle is the same as that described in the above embodiment.

Using the writing identification system 100 of the present application, one or more users, through an application installed on the user device 83, can instantly obtain the content written on the writing board 81 on which the content includes the writing color and the handwriting. Particularly, when using writing instruments of different colors, users only need to pick up the writing instrument of a required color and write on the writing board 81 in the same way as using a general whiteboard pen, without the need to set the color through setting functions of traditional electronic whiteboards. In some embodiments, users can use the writing instruments 82 of the same or different colors to write on the writing board 81, and can write on the writing board 81 at the same time with a single or a plurality of the writing instruments 82, and remote users can clearly learn the writing color and the handwriting.

Still referring to FIGS. 10 and 11 together with FIG. 8, the working principle of identifying the electronic eraser 4 of the present application is the same as that of the writing instrument 82. Specifically, taking the electronic eraser 4 shown in FIG. 8 as an example, when the wiping portion 42 contacts the writing board 81, a coupling effect is formed between the touch control panel 1 and the conductive element 43, and the touch control panel 1 sends a second identification signal. When the wiping portion 42 moves and wipes on the writing board 81, the touch control panel 1 generates a wiping touch signal, and the pairing device 3 receives the second identification signal and the wiping touch signal to generate a second pairing signal, and transmits the second pairing signal to the user device 83. Users of user devices can immediately know that the content on the writing board 81 has been erased by the electronic eraser 4.

Still referring to FIGS. 10 and 11 together with FIG. 9, taking the electronic eraser 4 shown in FIG. 9 as an example, when the wiping portion 42 contacts the writing board 81, the identification element 44 sends the second identification signal, and when the wiping portion 42 moves on the writing board 81, the touch control panel 1 generates the wiping touch signal, the pairing device 3, in response to receiving the second identification signal and the wiping touch signal, generates the second pairing signal and transmits the second pairing signal to the user device 83.

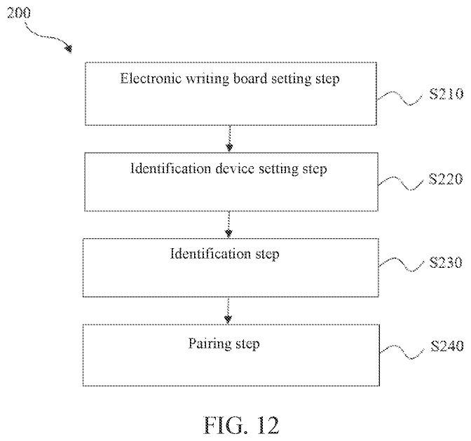

Referring to FIG. 12, FIG. 12 shows a flowchart of a writing identification method according to an embodiment of the present application. The writing identification method is used for at least a user device to identify a writing instrument and handwriting with the writing instrument on a writing board. As shown in FIG. 12, the writing identification method 200 of the present application includes the following steps:

An electronic writing board setting step S210 includes setting a touch control panel on a back of the writing board. Specifically, the touch control panel generates a handwriting touch signal according to the handwriting of the writing instrument.

An identification device setting step S220 includes installing an identification device on the writing instrument. The detailed structure of the identification device is the same as the identification device described in the above embodiments and will not be repeated here.

An identification step S230 includes using the wireless transmission module, in response to that the trigger sensor senses the displacement and a time the writing head of the writing instrument contacts the writing board, to transmit a first identification signal.

A pairing step S240 includes electrically connecting a pairing device to the touch control panel for receiving the first identification signal and the handwriting touch signal to generate a first pairing signal and transmit the first pairing signal to the user device.

It should be noted that further description of the components and operations required in the above-mentioned identification device setting step S220, the identification step S230, and the pairing step S240 has been described in detail in the above-mentioned writing identification system in each embodiment, and is therefore not repeated here.

In addition, the writing identification method of the present application further includes providing an electronic eraser to wipe the handwriting. The identification method and operation of the electronic eraser have been described in detail in each of the above-mentioned embodiments, so they will not be repeated here.

To sum up, the writing identification system and method provided in the present application can be used with general commercially available whiteboard pens and whiteboards. The identification device is installed on the writing instrument and the first identification signal is transmitted to the writing instrument using a wireless signal transmission method. The pairing device receives the first identification signal and the handwriting touch signal sent by the touch control panel to generate the first pairing signal and transmits the first pairing signal to the user device. In addition, the writing identification system and method of the present application receives the second identification signal and the wiping touch signal through the pairing device, and then sends the second pairing signal for identifying the eraser. With the above writing identification system and method, when intending to use writing instruments of different colors, users only need to pick up the writing instrument of the required color and write on the writing board. It is the same as using general whiteboard pens, without the need to set the color through setting functions of traditional electronic whiteboards, which is not only convenient, fast, and accurate to achieve the identification effect, but also remains the use of original whiteboard pens and whiteboards, thus effectively reducing costs and preventing the waste of resources.

Accordingly, although the present invention has been disclosed as a preferred embodiment, it is not intended to limit the present invention. Those skilled in the art without departing from the scope of the present invention may make various changes or modifications, and thus the scope of the present invention should be after the appended claims and their equivalents.

What is claimed is:

1. A writing identification system adapted for at least a user device to identify a writing instrument and handwriting with the writing instrument on a writing board, the writing identification system comprising:
a touch control panel disposed on a back of the writing board and configured to generate a handwriting touch signal according to the handwriting of the writing instrument;
an identification device comprising:
a housing assembly detachably attached to the writing instrument and comprising a first cover disposed on an end of the writing instrument opposite to a writing head included in the writing instrument;
a trigger sensor disposed in the first cover and configured to sense displacement of the writing instrument;
a wireless transmission module disposed in the first cover and electrically connected to the trigger sensor, wherein the wireless transmission module, in response to that the trigger sensor senses the displacement and a time the writing head of the writing instrument contacts the writing board, transmits a first identification signal, and
a power module disposed in the housing assembly and configured to supply power to the trigger sensor and the wireless transmission module; and
a pairing device electrically connected to the touch control panel and generating, in response to receiving the first identification signal and the handwriting touch signal, a first pairing signal and transmitting the first pairing signal to a remote device.

2. The writing identification system of claim 1, wherein the trigger sensor comprises a trigger portion positioned in contact with an end of the writing instrument away from the writing head and configured to sense the displacement of the writing instrument when contact pressure is applied on the writing board from the writing instrument.

2. The writing identification system of claim 1, wherein the displacement of the writing instrument comprises acceleration of the writing instrument, and the trigger sensor is configured to sense the acceleration of the writing instrument moving from outside the writing board to be in contact with the writing board.

3. The writing identification system of claim 1, wherein the housing assembly further comprises a housing body configured along the writing instrument, and the housing body comprises a mounting opening positioned close to the writing head of the writing instrument, wherein the first cover is installed on an end of the housing body away from the mounting opening.

4. The writing identification system of claim 4, wherein the housing assembly further comprises a second cover installed on an end of the mounting opening of the housing body, and the second cover comprises a through hole through which the writing head passes.

5. The writing identification system of claim 1, wherein the first pairing signal comprises identification data containing a writing color of the writing instrument, wherein the time the writing head of the writing instrument contacts the writing board excludes a writing time when the writing head writes on the writing board to generate the handwriting, and the wireless transmission module does not transmit the first identification signal during the writing time.

6. The writing identification system of claim 1, further comprising an electronic eraser comprising an eraser body, a wiping portion, and at least a conductive element, wherein the conductive element is disposed in the wiping portion or the eraser body.

7. The writing identification system of claim 7, wherein the electronic eraser further comprises an identification element disposed in the eraser body, and the conductive element is disposed in the wiping portion and connected to the identification element, wherein when the wiping portion contacts the writing board, the identification element sends out a second identification signal, and when the wiping portion moves on the writing board, the touch control panel generates a wiping touch signal, and the pairing device, in response to receiving the second identification signal and the wiping touch signal, generates a second pairing signal and transmits the second pairing signal to the user device.

8. The writing identification system of claim 7, wherein when the wiping portion contacts the writing board, a coupling effect is formed between the touch control panel and the conductive element, and the touch control panel, in response to the coupling effect, sends a second identification signal, and when the wiping portion moves on the writing board, the touch control panel generates a wiping touch signal, and the pairing device, in response to receiving the second identification signal and the wiping touch signal, generates a second pairing signal and transmits the second pairing signal to user device.

9. The writing identification system of claim 1, wherein the pairing device comprises a processor and a signal transceiver module electrically connected to the processor.

10. A writing identification method for at least a user device to identify a writing instrument and handwriting with the writing instrument on a writing board, the writing identification method comprising:
an electronic writing board setting step comprising setting a touch control panel on a back of the writing board, wherein the touch control panel generates a handwriting touch signal according to the handwriting of the writing instrument;
an identification device setting step comprising installing an identification device on the writing instrument, wherein the identification device comprises:
a housing assembly detachably attached to the writing instrument and comprising a first cover disposed on an end of the writing instrument opposite to a writing head included in the writing instrument;
a trigger sensor disposed in the first cover and configured to sense displacement of the writing instrument;
a wireless transmission module disposed in the first cover and electrically connected to the trigger sensor; and
a power module disposed in the housing assembly and configured to supply power to the trigger sensor and the wireless transmission module;
an identification step comprising using the wireless transmission module, in response to that the trigger sensor senses the displacement and a time the writing head of the writing instrument contacts the writing board, to transmit a first identification signal; and
a pairing step comprising electrically connecting a pairing device to the touch control panel for receiving the first identification signal and the handwriting touch signal to generate a first pairing signal and transmit the first pairing signal to the user device.

11. The writing identification method of claim 11, wherein the trigger sensor comprises a trigger portion positioned in contact with an end of the writing instrument away from the writing head and configured to sense displacement of the writing instrument when contact pressure is applied on the writing board from the writing instrument.

12. The writing identification method as claimed in claim 11, wherein the displacement of the writing instrument comprises acceleration of the writing instrument, and the trigger sensor is configured to sense the acceleration of the writing instrument moving from outside the writing board to be in contact with the writing board.

13. The writing identification system of claim 11, wherein the first pairing signal comprises identification data containing a writing color of the writing instrument, wherein the time the writing head of the writing instrument contacts the writing board excludes a writing time when the writing head writes on the writing board to generate the handwriting, and the wireless transmission module does not transmit the first identification signal during the writing time.

14. The writing identification method as claimed in claim 11, wherein the housing assembly further comprises a housing body configured along the writing instrument and comprising a mounting opening, and the identification device setting step further comprises:
installing the housing body on the writing instrument such that the mounting opening is positioned close to the writing head of the writing instrument; and
installing the first cover on an end of the housing body away from the mounting opening.

15. The writing identification method of claim 15, wherein the housing assembly further comprises a second cover with a through hole, and the identification device setting step further comprises:
installing the second cover on an end of the mounting opening of the housing body such that the writing head of the writing instrument is exposed to the through hole.

16. The writing identification method of claim 11, wherein the pairing device comprises a processor and a signal transceiver module electrically connected to the processor, and the pairing step comprises:
using the signal transceiver module to receive the first identification signal through a wireless transmission manner, and receive the handwriting touch signal;
using the processor to pair the first identification signal with the handwriting touch signal through an algorithm to generate the first pairing signal; and
using the signal transceiver module to transmit the first pairing signal to the user device through the Internet in the wireless transmission manner.

17. The writing identification method of claim 11, further comprising:
providing an electronic eraser, comprising an eraser body, a wiping portion, at least a conductive element, and an identification element disposed in the eraser body, wherein the conductive element is disposed in the wiping portion and connected to the identification element, wherein when the wiping portion contacts the writing board, the identification element sends out a second identification signal, and when the wiping portion moves on the writing board, the touch control panel generates a wiping touch signal, and the pairing device, in response to receiving the second identification signal and the wiping touch signal, generates a second pairing signal and transmits the second pairing signal to the user device.

18. The writing identification method of claim 11, further comprising:
providing an electronic eraser, comprising an eraser body, a wiping portion, and at least a conductive element, wherein the conductive element is provided in the wiping portion or the eraser body, wherein when the wiping portion contacts the writing board, a coupling effect is formed between the touch control panel and the conductive element, and the touch control panel, in response to the coupling effect, sends a second identification signal, and when the wiping portion moves on the writing board, the touch control panel generates a wiping touch signal, and the pairing device, in response to receiving the second identification signal and the wiping touch signal, generates a second pairing signal and transmits the second pairing signal to user device.
